(19) United States
(12) Patent Application Publication
(10) Pub. No.: US 2011/0078629 A1
(43) Pub. Date: Mar. 31, 2011

(54) ELECTRONIC DEVICE CAPABLE OF AUTOMATICALLY GENERATING USER INTERFACE AND METHOD THEREOF

(75) Inventors: ZHAO-PING ZHANG, Shenzhen City (CN); HUA-DONG CHENG, Shenzhen City (CN); LING CHANG, Shenzhen City (CN); HAN-CHE WANG, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/610,367

(22) Filed: Nov. 2, 2009

(30) Foreign Application Priority Data
Sep. 29, 2009 (CN) 200910307997.4

(51) Int. Cl. G06F 3/048

(52) U.S. Cl. 715/811; 715/841

(57) ABSTRACT

An electronic device is provided. The electronic device includes an input unit, a display unit and a storage unit. The storage unit stores a product function list and a plurality of UI profile files. Each of the UI profile files defines one display format. A UI (user interface, UI) establishing module activates a function of the electronic device for establishing a UI. A product function list loading module loads the product function list from the storage unit. A product function list parsing module parses the loaded product function list. A user interface profile file loading module selectively loads the UI profile file from the storage unit. A user interface generation module displays the parsed product function list on the display unit according to the display format of the selective UI profile file, and links the generated menu interfaces to generate a series of user interfaces.

### BACKGROUND

1. Technical Field

The present disclosure relates to an electronic device capable of automatically generating a user interface and a method thereof.

2. Description of Related Art

In general, user interface (UI) engineers manually produce a user interface according to a product function list and a UI profile file. However, when the UI profile is changed, the user interface has to be changed too. As a result, UI engineers have to re-produce the UI over again, and this would be time-consuming to re-produce the UI.

Therefore, what is needed is an electronic device which can automatically generate a user interface and a method for such an electronic device.

### BRIEF DESCRIPTION OF THE DRAWINGS

FIG. 1 is a block diagram of the hardware infrastructure of an electronic device configured for automatically generating a user interface in accordance with an exemplary embodiment.

FIG. 2 is a schematic diagram of a product function list which is parsed in a database in accordance with an exemplary embodiment.

FIG. 3 is a series of user interface of a ring menu of FIG. 2 which is displayed according to a display format of the second UI profile file.

FIG. 4 is a flowchart of an automatically generating user interface method implemented by the electronic device of FIG. 1, in accordance with an exemplary embodiment.

### DETAILED DESCRIPTION

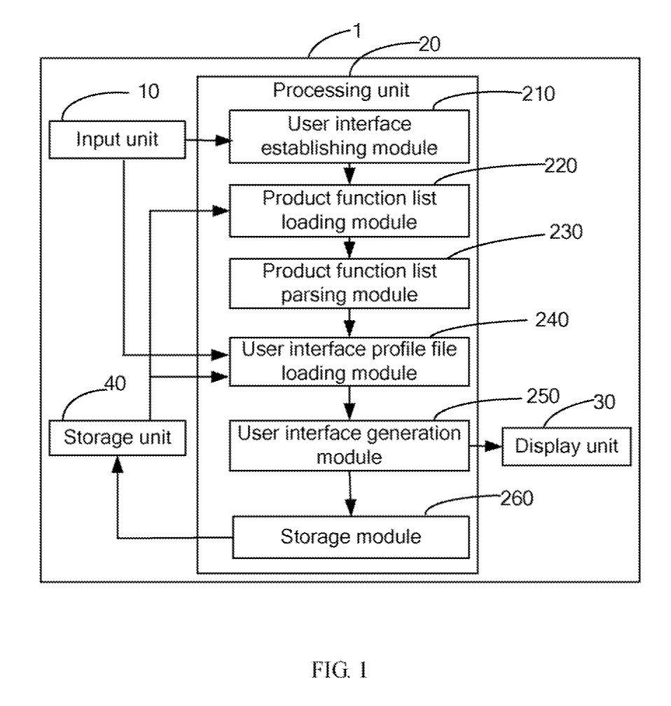

FIG. 1 is a block diagram of the hardware infrastructure of an electronic device in accordance with an exemplary embodiment. The electronic device 1 includes an input unit 10, a processing unit 20, a display unit 30, and a storage unit 40. The input unit 10 is configured for receiving input operations. The display unit 30 is configured for displaying a UI of the electronic device 1. The storage unit 40 is configured for storing a product function list and a plurality of UI profile files.

The product function list defines relationships between features of the electronic device. In the exemplary embodiment, the relationships of the product are represented as menu items and sub-menu items of a menu corresponding to features of the device. The product function list further defines menu options and submenu options.

The UI profile file is a display specification file and defines a display interface for showing the relationships of the product. That is, the UI profile file defines a display interface for listing/organizing the menu items and the submenus items. Each of the UI profile file further defines one display format of the display interface. The display format includes a display manner of the menu, background color, and highlight color on option, etc. For example, there are two UI profile files: a first UI profile file and a second UI profile file. Regarding to the first UI profile file, the display manner of the menu may be listing menu items horizontally and listing submenu items vertically in a menu interface, and listing the submenu items horizontally and listing the options of the each of the submenu items vertically in a submenu interface. The background color is blue. The highlight color is red. Regarding to the second UI profile file, the display manner of the menu may be listing menu items vertically and listing submenu items horizontally in a menu interface, and listing the submenu items vertically and listing the options of the each of the submenu items horizontally in a submenu interface. The background color is white. The highlight color is green.

The processing unit 20 includes a user interface establishing module 210, a product function list loading module 220, a product function list parsing module 230, a user interface profile file loading module 240, a user interface generation module 250, and a storage module 260.

The user interface establishing module 210 is configured for activating a function of the electronic device 1 for establishing a UI, when the input unit 10 receives an input operation of establishing a UI.

The product function list loading module 220 is configured for loading the product function list from the storage unit 40, when the function of the electronic device 1 for establishing the UI is activated.

The product function list parsing module 230 is configured for parsing the loaded product function list, when the product function list is loaded.

In the exemplary embodiment, each of the menu item is assigned a one-level node, and each of the sub-menu item of the sub-menu is assigned a two-level node, etc, by the same token, all menu items are assigned a corresponding level node. The product function list parsing module 230 first identifies the first one-level node, and then identifies whether the first one-level node includes the two-level node. If the first one-level node includes the two-level node, the product function list parsing module 230 identifies whether the two-level node includes a three-level node until that the last-level node is identified, and acquires the corresponding options corresponding to the identified last-level node. Then, the product function list parsing module 230 identifies the second one-level node, and repeats the above operation to identify the all nodes, and acquires the all options. If the first one-level node does not include the two-level node, the product function list parsing module 230 acquires the option corresponding to the first one-level node, and then identifies the second one-level node, by the same token, repeats the above operation until that the last-level node is identified, and acquires the options corresponding to the identified last-level node. Finally, the product function list parsing module 230 stores the menu items corresponding to the all one-level nodes in a first layer of a database, stores the sub-menu items corresponding to the all two-level nodes in a second layer of the database, by the same token, and stores the options of menu items of the menu or the sub-menus in a last layer of the database.

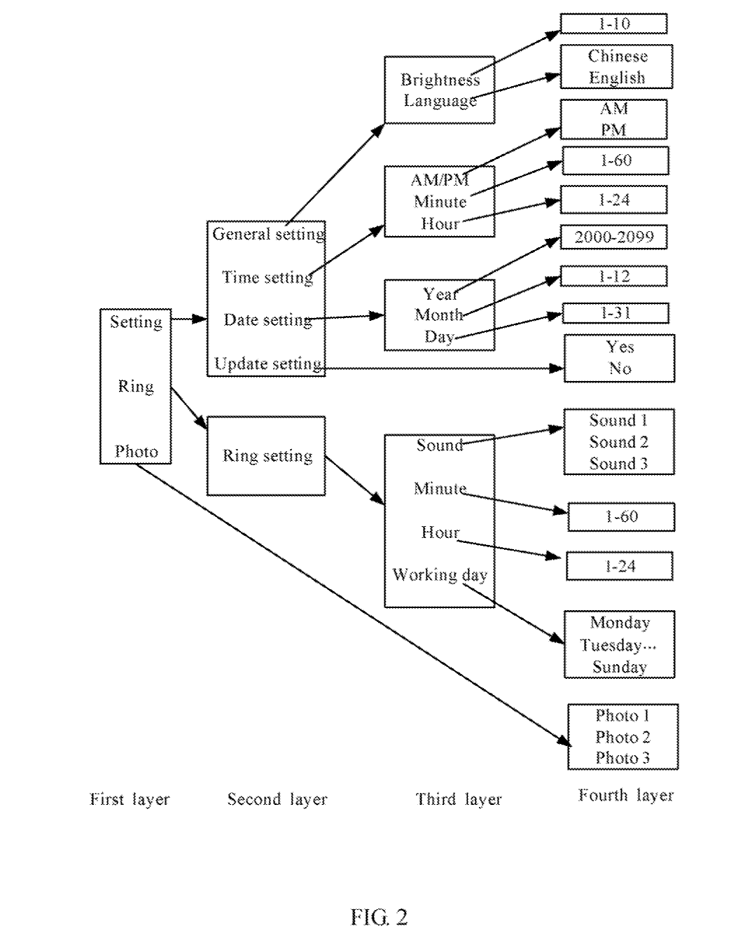

As shown FIG. 2, a schematic diagram of a product function list which is parsed in the database in accordance with an exemplary embodiment is provided. The first layer of the database stores three menu items; the second layer of the database stores the sub-menu items of the menu in the first layer; the third layer of the database stores the sub-menu items of the sub-menus in the second layer; the fourth layer of the database stores the options corresponding to the menus or the sub-menus.

The user interface profile file loading module 240 is configured for selectively loading the UI profile file from the storage unit 40 according to an input operation the input unit 10 receives, when the product function list is parsed. In the exemplary embodiment, the user interface profile file loading module 240 may selectively load one of the UI profile files for the all menu items according to the input operation, that is, all menus can be displayed according to the same display format of the selective UI profile file. In another embodiment, the user interface profile file loading module 240 may selectively load different UI profile files for the different menu items, that is, each of the menu items can be displayed according to the different display format of the selective UI profile file.

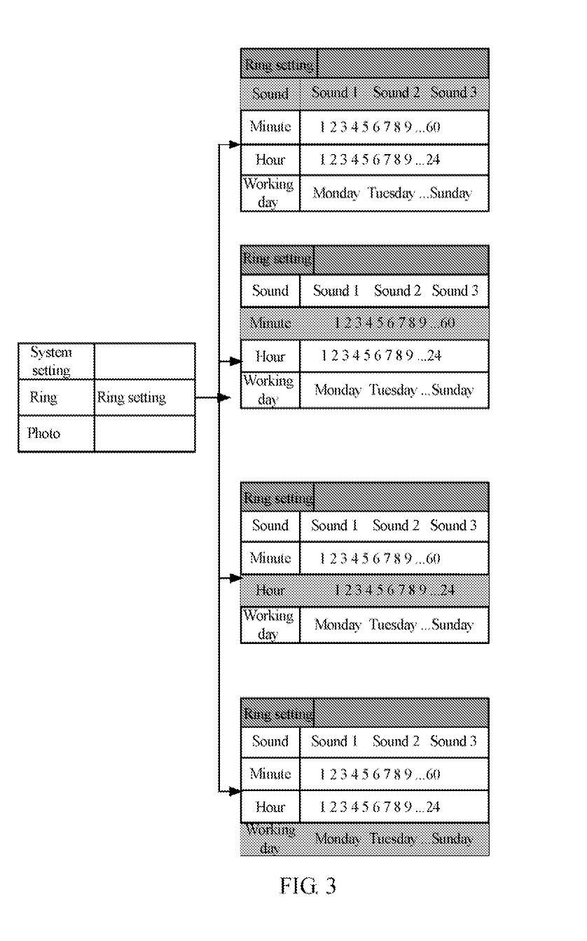

The user interface generation module 250 is configured for displaying the parsed product function list on the display unit 30 according to the display format of the loaded UI profile file, and linking the displaying menu interface to generate a series of UIs, when the UI profile file is loaded. As shown FIG. 3 is a series of user interfaces of the ring menu item of FIG. 2 which is displayed according to the display format of the above second UI profile file.

The storage module 260 is configured for storing the generated series of user interfaces in the storage unit 40.

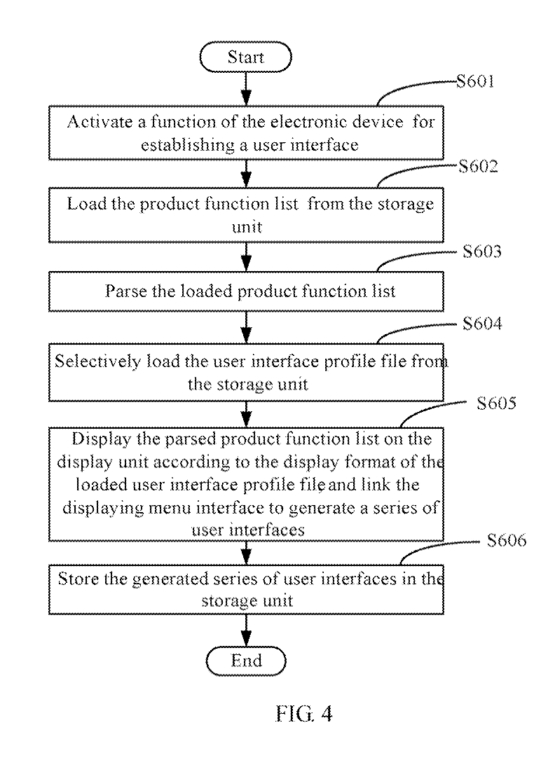

FIG. 4 is a flowchart of a method of automatically generating user interface implemented by the electronic device of FIG. 1, in accordance with an exemplary embodiment.

In step S601, the user interface establishing module 210 activates a function of the electronic device 1 for establishing a UI, when the input unit 10 receives an input operation of establishing a UI.

In step S602, the product function list loading module 220 loads the product function list from the storage unit 40, when the function for establishing the UI is activated.

In step S603, the product function list parsing module 230 parses the loaded product function list, when the product function list is loaded.

In step S604, the user interface profile file loading module 240 selectively loads the UI profile file from the storage unit 40 according to an input operation the input unit 10 receives, when the product function list is parsed.

In step S605, the user interface generation module 250 displays the parsed product function list on the display unit 30 according to the display format of the loaded UI profile file, and links the displaying menu interface to generate a series of UIs, when the UI profile file is loaded.

In step S606, the storage module 260 stores the generated series of user interfaces in the storage unit 40.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device capable of automatically generating a user interface, the electronic device comprising:
an input unit configured for receiving an input operation;
a display unit configured for displaying a user interface (UI) of the electronic device;
a storage unit configured for storing a product function list and a plurality of UI profile files; wherein each of the UI profile files defines one display format;
a user interface establishing module configured for activating a function of the electronic device for establishing a UI, when the input unit receives the input operation of establishing the UI;
a product function list loading module configured for loading the product function list from the storage unit, when the function of the electronic device for establishing the UI is activated;
a product function list parsing module configured for parsing the loaded product function list, when the product function list is loaded;
a user interface profile file loading module configured for selectively loading one UI profile file from the storage unit, when the product function list is parsed; and
a user interface generation module configured for displaying the parsed product function list on the display unit according to the display format of the selective UI profile file, and linking the generated menu interfaces to generate a series of user interfaces.

2. The electronic device as claim 1, further comprising:
a storage module, which is configured for storing the generated series of user interfaces in the storage unit.

3. The electronic device as claim 1, wherein the product function list defines relationships between features of the electronic device.

4. The electronic device as claim 3, wherein relationships of the product are represented as menu items and sub-menu items of a menu corresponding to features of the device.

5. The electronic device as claim 4, wherein the product function list further defines menu options and submenu options.

6. The electronic device as claim 5, wherein each of the menu items is assigned a one-level node, and each of the sub-menu items of the sub-menu is assigned a two-level node, by the same token, all menu items are assigned a corresponding level node;
the product function parsing module first identifies the first one-level node, and identifies the first one-level node whether comprises a two-level node;
if the first one-level node comprises a two-level node, the product function parsing module identifies whether the two-level node comprises a three-level node until that the last-level node is identified, and acquires the options corresponding to the identified last-level node, and identifies the second one-level node, and repeats the above operation;
if the first one-level mode does not comprise the two-level node, the product function parsing module acquires the options corresponding to the first one-level node, and identifies the second one-level node, and repeats the above operation until that the last-level node is identified, and acquires the options corresponding to the identified last-level node.

7. The electronic device as claim 1, wherein the user interface profile file is a display specification document and defines a display interface for showing the relationships of the product.

8. The electronic device as claim 1, wherein the user interface profile file loading module selectively loads one of the UI profile files for the all menu items of the menu.

9. The electronic device as claim 1, wherein the user interface profile file loading module selectively loads the different UI profile files for the different menu items of the menu.

10. A method for automatically generating user interface implemented by an electronic device, which comprises an input unit, a display unit, and a storage unit, wherein the display unit displays the UI of the electronic device, the storage unit stores a product function list and a plurality of UI profile files; each of the UI profile files defines one display format; the method comprising:
activating a function of the electronic device for establishing a UI, when the input unit receives an input operation of establishing the UI;
loading the product function list from the storage unit, when the function for establishing the UI is activated;
parsing the loaded product function list, when the product function list is loaded;
selectively loading the UI profile file from the storage unit, when the product function list is parsed; and
displaying the parsed product function list on the display unit according to the display format of the selective UI profile file, and linking the generated menu interfaces to generate a series of user interfaces.

11. The method as claim 10, further comprising: storing the generated series of user interfaces in the storage unit.

12. The method as claim 11, wherein the product function list defines relationships between features of the electronic device.

13. The method as claim 12, wherein the relationships of the product are represented as menu items and sub-menu items of a menu corresponding to features of the device.

14. The method as claim 13, wherein the product function list further defines menu options and submenu options.

15. The method as claim 14, wherein parsing the product function list step further comprises:
each of the menu items being assigned a one-level node, and each of the sub-menu items of the sub-menu of the menu being assigned a two-level node; by the same token, all menu items being assigned a corresponding level node;
identifying the first one-level node, and identifying whether the first one-level node comprises a two-level node;
if the first one-level node comprises a two-level node, identifying whether the two-level node includes a three-level node until that the last-level node is identified, acquiring the options corresponding to the identified last-level node, and identifying the second one-level node, and repeating the above operation;
if the first one-level mode does not include the two-level node, acquiring the options corresponding to the first one-level node, identifying the second one-level node, and repeating the above operation until that the last-level node is identified, and acquiring the options corresponding to the identified last-level node.

16. The method as claim 10, wherein the UI profile file is a display specification document and defines a display interface for showing the relationships of the product.

17. The method as claim 10, wherein the method comprises: selectively loading one of the UI profile files for the all menu items of the menu.

18. The method as claim 10, wherein the method comprises: selectively loading the different UI profile files for the different menu items of the menu.
